(19) United States
(12) Patent Application Publication
(10) Pub. No.: US 2005/0173895 A1
(43) Pub. Date: Aug. 11, 2005

(54) Device for controlling folding operation of golf cart

(76) Inventor: Wen-Tsan Lin, Taichung (TW)

Correspondence Address: WEN-TSAN LIN, 235 Chung - Ho, Box 8-24, Taipei, TW

(21) Appl. No.: 10/773,855

(22) Filed: Feb. 9, 2004

(51) Int. Cl. B62B 1/00

(52) U.S. Cl. 280/651

(57) ABSTRACT

A device for controlling the folding operation of a golf cart comprises at least one first joint; at least one second joint which is rotatable and movable along an axial direction with respect to the first joint; at least one elastomer installed between the first joint and second joint; a spindle passing through the first joint, the second joint and the elastomer; a tightening element installed at a distal end of the spindle for pressing the second joint to move axially toward the first joints and then tightly resist against the first joints. The tightening element serves to give a pressure to the second joint and the first joint. The elastomer is compressed and thus store potential energy. When the tightening element is released, the elastomers will eject the first joint and the second joints.

### FIELD OF THE INVENTION

The present invention relates to golf carts, and particular to a device for controlling a folding operation of a golf cart, by that, a golf cart body can be folded for storage so as to be carried easily or stored with a smaller volume.

### BACKGROUND OF THE INVENTION

Conventionally, a golf cart body has a rigid structure, that is, it is unfoldable. However, in general, the cart body has a larger volume so that it is tedious to store or carry the golf cart. Although some foldable golf carts are developed for improving the defects in the prior art, but they can not be operated easily and inconveniently, and the costs are high.

### SUMMARY OF THE INVENTION

Accordingly, the primary object of the present invention is to provide a device for controlling a folding operation of a golf cart, by that, a golf cart body can be folded for storage so as to be carried easily or stored with a smaller volume.

To achieve above objects, the present invention provides a device for controlling the folding of a golf cart comprises at least one first joint; at least one second joint which is rotatable and movable along an axial direction with respect to the first joint; at least one elastomer installed between the first joint and second joint; a spindle passing through the first joint, second joints and the elastomer; a tightening element installed at a distal end of the spindle for pressing the second joint to move axially toward the first joint and then tightly resist against the first joint. The tightening element serves to give a pressure to the second joint and the first joint. The elastomer is compressed and thus store potential energy. When the tightening element is released, the elastomers will eject the first joint and the second joints.

The various objects and advantages of the present invention will be more readily understood from the following detailed description when read in conjunction with the appended drawing.

### BRIEF DESCRIPTION OF THE DRAWINGS

FIG. 1 is a schematic perspective view of the device for controlling a folding operation of a golf cart of the present invention.

FIG. 2 is an exploded perspective view of the device of the present invention, wherein the first joint is an integrally-formed body.

FIG. 3 is an assembled cross section view of the present invention.

FIG. 4 is an exploded perspective view of the device of the present invention, wherein the first joint is formed by a left first joint and a right first joint.

FIG. 5 is a schematic view showing the operation of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

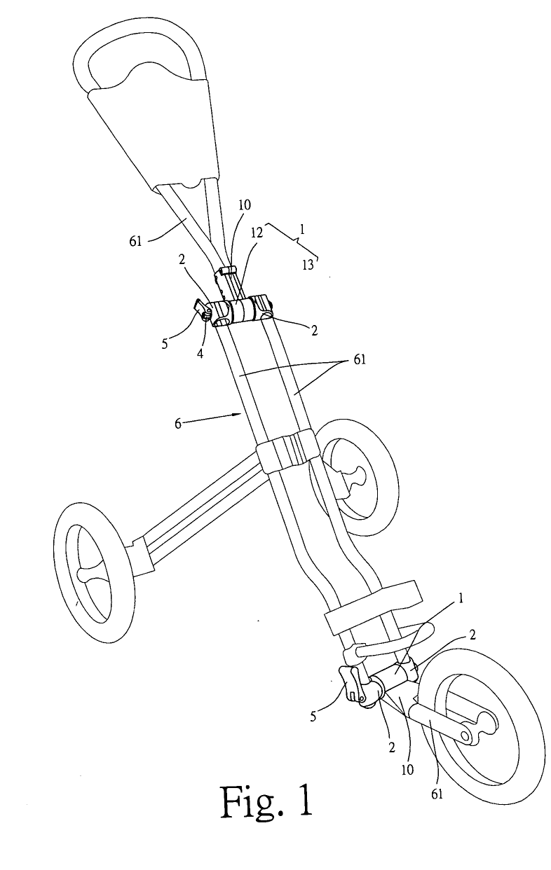

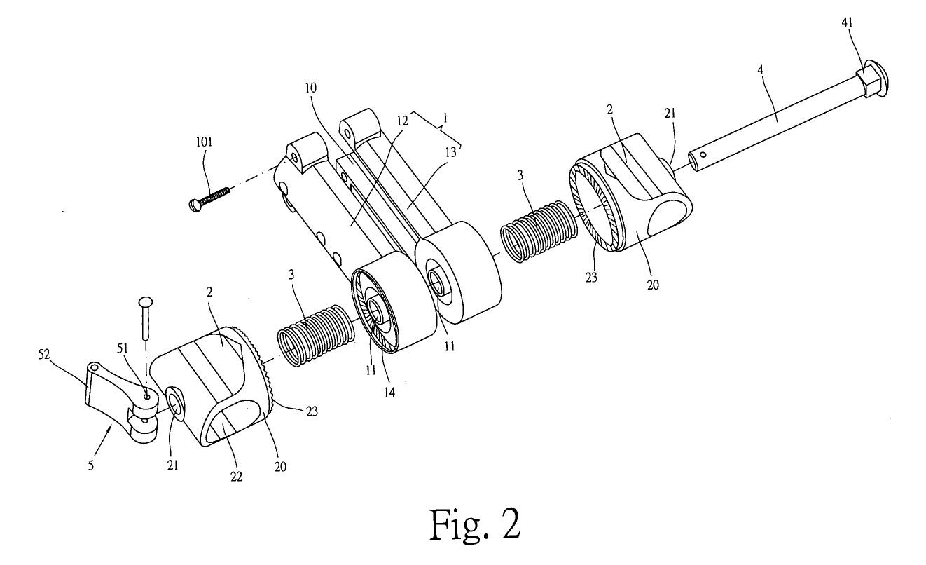

With reference to FIGS. 1 and 2, the device for controlling the folding of a golf cart of the present invention is illustrated. The device includes at least one first joint 1 and a second joint 2 which are rotatable with respect to one another and are movable along an axial direction. In the illustrated drawings, one first joint 1 and two second joints 2 are illustrated, which are used in the description of this embodiment. The second joints 2 are located at two outer sides of the first joint 1. However, this is only one embodiment of the present invention, but not used to confine the scope of the present invention. Other examples which match the scope and spirit of the present invention described in the claims are within the confinement of the present invention.

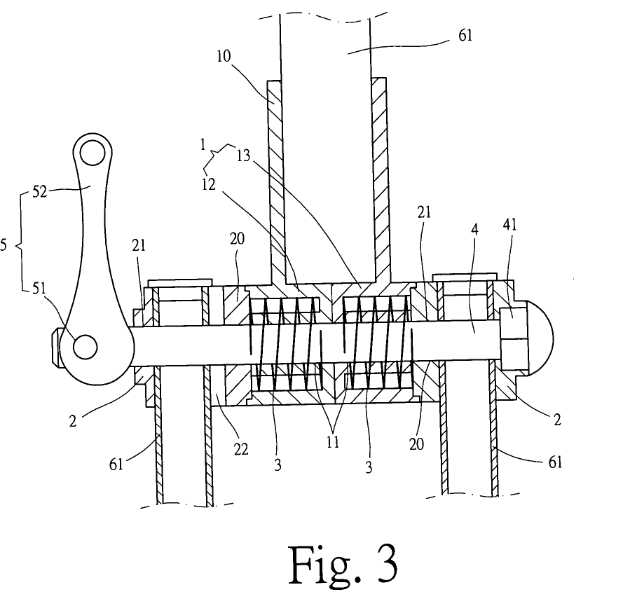

With reference to FIGS. 2 and 3, two elastomers 3 is installed between the first joint 1 and second joints 2. Preferably, the elastomer 3 is a spring.

Referring to FIGS. 2 and 3, a spindle 4 passes through the first joint 1, second joints 2 and the elastomers 3.

With reference to FIGS. 1 to 3, a tightening element 5 is installed at a distal end of the spindle 4 for pressing the second joint 2 to move axially toward the first joints 1 and then tightly resist against the first joints 1.

Referring to FIGS. 1 to 5, the first joint 1 further includes at least one combining portion 10 for combining with a golf cart body 6. The shape and structure of the combining portion 10 are made according to a card rod 61 of the golf cart body 6.

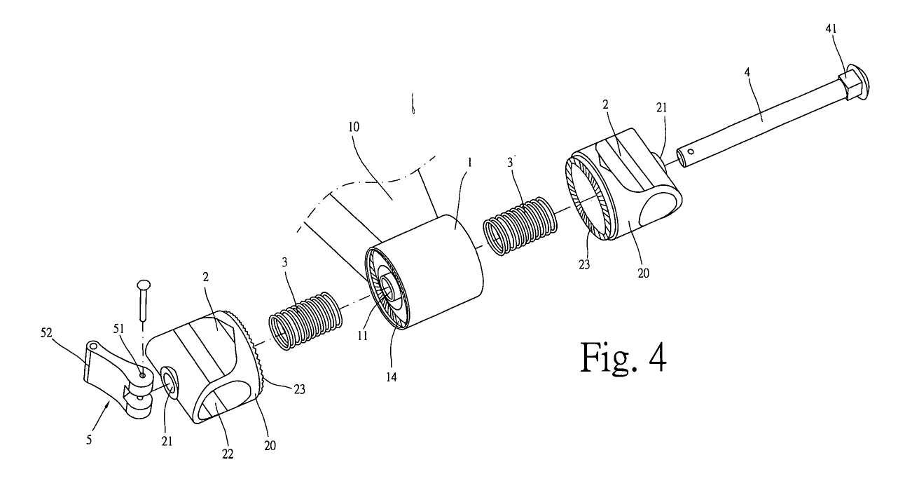

In the present invention, as shown in FIG. 4, the first joint 1 of the present invention can be made integrally. Or as shown in FIG. 2, it can be formed by a left first joint 12 and a right first joint 13. The way for combining the first joint 1 may use screws 101, adhesive, or supersonic waves, etc.

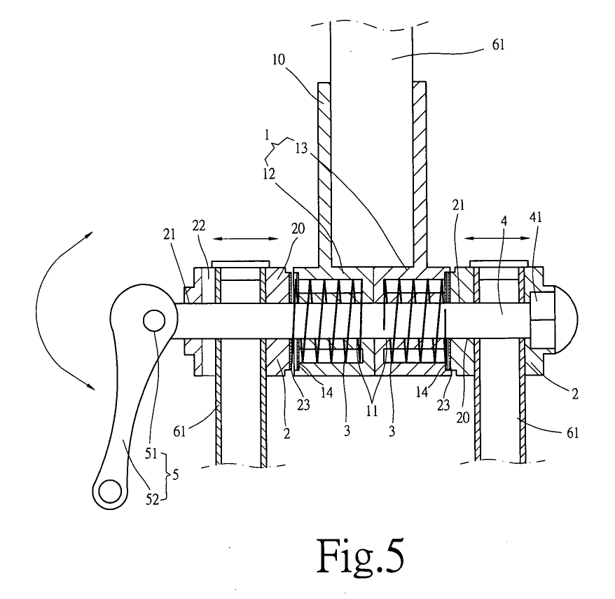

With reference to FIGS. 1 to 5, the second joints 2 have respective combining portions 20 which can be combined to the cart rods 61 of the golf cart body 6. Preferably, the combining portions 20 have respective through holes 22. Outer diameters of two through holes 22 are larger than those of the cart rods 61, as shown in FIGS. 3 and 5.

With reference to FIGS. 2 and 3, in the present invention, the connecting surfaces of the first joint 1 and the second joints 2 are formed with coarse surfaces 14, and 23 respectively. Preferably, the coarse surfaces 14 and 23 are teethed surfaces.

Referring to FIG. 2, in the present invention, the first joint 1 has an axial hole 11 and each of the second joint 2 has an axial hole 21 so that the spindle 4 passes through the axial holes 11 and 21. A limiting means 41 is located between one of the two second joints 2 far away from the tightening element 5 and the spindle. Thereby, the spindle 4 cannot rotate with respect to the second joint 2.

With reference to FIGS. 2 and 3, one end of the tightening element 5 has an eccentric hole 51 for receiving the spindle 4. Another end of the tightening element 5 has a control spanner 52 for controlling the rotation of the tightening element 5.

Referring to FIGS. 2 and 5, by above said elements, in the present invention, the tightening element 5 serves to give a pressure to the second joints 2 and the first joint 1. The elastomers 3 are compressed and thus store potential energy. When the tightening element 5 is released, the elastomers 3 will eject the first joint 1 and the second joints 2. Thus, the first joint 1 can rotate with respect to the second joints 2 for expanding or folding the cart rod 61.

Thereby, by above mentioned device for controlling a folding operation of a golf cart according to the present invention, a golf cart body is folded for storage so as to be carried easily or stored with a smaller volume.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A device for controlling the folding operation of a golf cart comprising:
at least one first joint;
at least one second joint which is rotatable and movable along an axial direction with respect to the first joint;
at least one elastomer installed between the first joint and second joint;
a spindle passing through the first joint, the second joints and the elastomer;
a tightening element installed at a distal end of the spindle for pressing the second joint to move axially toward the first joint and then tightly resist against the first joint;
wherein the tightening element serves to give a pressure to the second joint and the first joint; the elastomer is compressed and thus store potential energy; when the tightening element is released, the elastomers will eject the first joint and the second joints.

2. The device for controlling a folding operation of a golf cart as claimed in claim 1, wherein the first joint includes at least one combining portion for combining with a golf cart body.

3. The device for controlling a folding operation of a golf cart as claimed in claim 1, wherein one end of the tightening element has an eccentric hole for receiving the spindle and another end of the tightening element has a control spanner.

4. The device for controlling a folding operation of a golf cart as claimed in claim 1, wherein the first joint includes a left first joint and a second joint.

5. The device for controlling a folding operation of a golf cart as claimed in claim 1, wherein the second joint further includes at least one combining portion for combining with a golf cart body.

6. The device for controlling a folding operation of a golf cart as claimed in claim 5, wherein the combining portion has a through hole; an outer diameters of the through hole is larger than those of the cart rods.

7. The device for controlling a folding operation of a golf cart as claimed in claim 1, wherein each of the first joint and second joints has an axial hole so that the spindle passes through the axial holes of the first joint and second joints.

8. The device for controlling a folding operation of a golf cart as claimed in claim 1, wherein the elastomer is a spring.

9. The device for controlling a folding operation of a golf cart as claimed in claim 1, wherein connecting surfaces of the first joint and the second joints are formed with coarse surfaces, respectively.

10. The device for controlling a folding operation of a golf cart as claimed in claim 1, wherein a limiting means is located between the second joint and the spindle; thereby, the spindle cannot rotate with respect to the second joint.
